(19) United States
(12) Patent Application Publication
(10) Pub. No.: US 2023/0070635 A1
(43) Pub. Date: Mar. 9, 2023

(54) GENERATION METHOD, ESTIMATION METHOD, GENERATION DEVICE, AND ESTIMATION DEVICE

(71) Applicant: Panasonic Intellectual Property Management Co., Ltd., Osaka (JP)

(72) Inventors: NOBUO HARA, Osaka (JP); HIROKO YOSHIDA, Osaka (JP); AKIHISA NAKAHASHI, Osaka (JP)

(21) Appl. No.: 17/822,626

(22) Filed: Aug. 26, 2022

(30) Foreign Application Priority Data
Sep. 3, 2021 (JP) 2021-144322

(51) Int. Cl. G05B 19/418

(52) U.S. Cl. CPC G05B 19/41885; G05B 2219/35206

(57) ABSTRACT

Experimental device machining is performed according to plan information including first type information indicating a first type condition of the experimental device machining and second type information indicating a second type condition of the experimental device machining. Third type information indicating a third type result and fourth type information indicating a fourth type result are acquired. Extended plan information is acquired in which a uniformity of extended second type information and extended third type information is equal to or greater than a threshold value. Extended third type information indicating a third type result and extended fourth type information indicating a fourth type result are acquired by performing the experimental device machining according to the extended plan information. An extended first relationship is derived that is a relationship between extended first type information, the extended second type information, and the extended third type information. An extended second relationship is derived that is a relationship between the extended first type information, the extended second type information, and the extended fourth type information. A model for estimating fourth type information indicating a fourth type result of actual device machining by receiving the second type information measured during the actual device machining and the third type information measured during the actual device machining and using the extended first relationship and the extended second relationship is generated. The model is output.

### BACKGROUND

### 1. Technical Field

The present disclosure relates to a generation method, an estimation method, a generation device, and an estimation device.

### 2. Description of the Related Art

Conventionally, models related to device machining are used. For such a model, many cases have been reported in which a parameter of an objective variable (output variable) is estimated from a parameter of an explanatory variable (input variable). In a case where a physical model can be configured based on an actual physical phenomenon, highly accurate estimation can be performed by estimating the parameter of the objective variable using this physical model, and the number of measurement steps required for modeling can also be suppressed.

Conversely, in a case where configuration of a physical model is difficult, for example, a method is known in which an input/output relationship is assumed through a polynomial model using a large amount of accumulated measurement data and the input/output relationship is estimated by fitting. An estimation method combining these two methods has also been proposed (see Patent Literature 1).

### Citation List

### Patent Literature

PTL 1: Japanese Patent No. 4539619

### SUMMARY

A generation method according to one aspect of the present disclosure is a generation method executed by a processor using memory, the generation method including: acquiring, by performing experimental device machining according to plan information including first type information indicating a first type condition of the experimental device machining and second type information indicating a second type condition of the experimental device machining, third type information indicating a third type result of the experimental device machining according to the plan information, and fourth type information indicating a fourth type result of the experimental device machining according to the plan information; acquiring extended plan information including extended first type information including new first type information added to the first type information and extended second type information including new second type information added to the second type information, in which a uniformity between the extended second type information and extended third type information obtained as the third type result of the experimental device machining performed according to the extended plan information is equal to or greater than a threshold value; acquiring, by performing the experimental device machining according to the extended plan information, the extended third type information indicating the third type result of the experimental device machining according to the extended plan information and extended fourth type information indicating the fourth type result of the experimental device machining according to the extended plan information; deriving an extended first relationship that is a relationship between the extended first type information, the extended second type information, and the extended third type information; deriving an extended second relationship that is a relationship between the extended first type information, the extended second type information, and the extended fourth type information; generating a model for estimating the fourth type information indicating the fourth type result of actual device machining by receiving the second type information measured during the actual device machining and the third type information measured during the actual device machining and using the extended first relationship and the extended second relationship; and outputting the model.

A generation device according to one aspect of the present disclosure includes a processor and memory connected to the processor, in which using the memory, the processor: acquires, by performing experimental device machining according to plan information including first type information indicating a first type condition of the experimental device machining and second type information indicating a second type condition of the experimental device machining, third type information indicating a third type result of the experimental device machining according to the plan information and fourth type information indicating a fourth type result of the experimental device machining according to the plan information; acquires extended plan information including extended first type information including new first type information added to the first type information and extended second type information including new second type information added to the second type information, in which a uniformity of the extended second type information and extended third type information obtained as the third type result of the experimental device machining performed according to the extended plan information is equal to or greater than a threshold value; acquires, by performing the experimental device machining according to the extended plan information, the extended third type information indicating the third type result of the experimental device machining according to the extended plan information and extended fourth type information indicating the fourth type result of the experimental device machining according to the extended plan information; derives an extended first relationship that is a relationship between the extended first type information, the extended second type information, and the extended third type information; derives an extended second relationship that is a relationship between the extended first type information, the extended second type information, and the extended fourth type information; generates a model for estimating the fourth type information indicating the fourth type result of actual device machining by receiving the second type information measured during the actual device machining and the third type information measured during the actual device machining and using the extended first relationship and the extended second relationship; and outputs the model.

These comprehensive or specific aspects may be achieved by a system, a method, an integrated circuit, a computer program, or a recording medium such as a computer-readable CD-ROM, or may be achieved by any combination of the system, the method, the integrated circuit, the computer program, and the recording medium.

### BRIEF DESCRIPTION OF THE DRAWINGS

FIG. 1 is a descriptive diagram illustrating a configuration of a system according to an exemplary embodiment;

FIG. 2 is a descriptive diagram illustrating processing of the system according to the exemplary embodiment;

FIG. 3 is a block diagram illustrating a functional configuration of a generation device according to the exemplary embodiment;

FIG. 4 is a descriptive diagram illustrating parameters related to a laser welding process;

FIG. 5 is a descriptive diagram illustrating a relationship between first to fourth parameters in an experiment according to the exemplary embodiment;

FIG. 6 is a descriptive diagram illustrating a relationship between the first to fourth parameters and first and second statistical model expressions derived by the generation device according to the exemplary embodiment;

FIG. 7 is a descriptive diagram illustrating a relationship between the first to third parameters and a third statistical model expression derived by the generation device according to the exemplary embodiment;

FIG. 8 is a descriptive diagram illustrating an estimation model generated by the generation device according to the exemplary embodiment;

FIG. 9 is a flowchart illustrating processing performed by the generation device according to the exemplary embodiment;

FIG. 10 is a block diagram illustrating a hardware configuration of an estimation device according to the exemplary embodiment;

FIG. 11 is a block diagram illustrating a functional configuration of the estimation device according to the exemplary embodiment;

FIG. 12 is a flowchart illustrating processing performed by the estimation device according to the exemplary embodiment;

FIG. 13 is a descriptive diagram illustrating an example of a first experimental design model acquired by the generation device according to the exemplary embodiment;

FIG. 14 is a descriptive diagram illustrating an example of results of an experiment performed according to the first experimental design model according to the exemplary embodiment;

FIG. 15 is a descriptive diagram illustrating an example of a second experimental design model acquired by the generation device according to the exemplary embodiment;

FIG. 16 is a descriptive diagram illustrating an example of extension of the second experimental design model acquired by the generation device according to the exemplary embodiment;

FIG. 17 is a descriptive diagram illustrating an example of extension of the first experimental design model according to the exemplary embodiment;

FIG. 18 is a descriptive diagram illustrating an example of results of an experiment performed according to the extended first experimental design model according to the exemplary embodiment;

FIG. 19 is a descriptive diagram illustrating an example of estimation accuracy of the estimation model according to the exemplary embodiment;

FIG. 20 is a flowchart illustrating processing performed by the generation device according to a variation of the exemplary embodiment; and

FIG. 21 is a flowchart illustrating processing performed by the estimation device according to the variation of the exemplary embodiment.

### DETAILED DESCRIPTIONS

In any conventional method, it is assumed that measurement data of a parameter of an explanatory variable is collected in-line during device machining.

Conversely, in order to obtain a model capable of estimating an objective variable with high accuracy, it is also assumed that the explanatory variable includes a parameter for which measurement data is not collected in-line. In this case, in order to enable utilization of the model in-line, it is necessary to take measures such as combining another experimental design having a parameter for which measurement data is not collected in-line as an output variable.

However, even if such measures are taken, it is assumed that the input variable of another experimental design cannot generate the experimental point as designed due to the nature of the variable. In addition, even if the experimental point can be generated as designed, there is a problem that the number of experiments required for generating the model is doubled because it is necessary to implement two experimental designs.

The present disclosure has been made in view of this problem of the prior art, and an object thereof is to provide a generation method for generating a model for appropriately estimating information indicating machining results and the like.

A generation method according to one aspect of the present disclosure is a generation method executed by a processor using memory. The generation method includes: acquiring, by performing experimental device machining according to plan information including first type information indicating a first type condition of the experimental device machining and second type information indicating a second type condition of the experimental device machining, third type information indicating a third type result of the experimental device machining according to the plan information and fourth type information indicating a fourth type result of the experimental device machining according to the plan information; acquiring extended plan information including extended first type information including new first type information added to the first type information and extended second type information including new second type information added to the second type information, in which a uniformity between the extended second type information and extended third type information acquired as the third type result of the experimental device machining performed according to the extended plan information is equal to or greater than a threshold value; acquiring, by performing the experimental device machining according to the extended plan information, the extended third type information indicating the third type result of the experimental device machining according to the extended plan information and extended fourth type information indicating the fourth type result of the experimental device machining according to the extended plan information; deriving an extended first relationship that is a relationship between the extended first type information, the extended second type information, and the extended third type information; deriving an extended second relationship that is a relationship between the extended first type information, the extended second type information, and the extended fourth type information; generating a model for estimating the fourth type information indicating the fourth type result of actual device machining by receiving the second type information measured during the actual device machining and the third type information measured during the actual device machining and using the extended first relationship and the extended second relationship; and outputting the model.

A generation method according to an aspect of the present disclosure can generate a model for appropriately estimating information indicating machining results. Specifically, according to the above aspect, it is possible to obtain a model for estimating the fourth type information in machining from the second type information and the third type information obtained during machining using the relationship between the first type information, the second type information, the third type information, and the fourth type information obtained from an experiment. By using this model, even when the fourth type information cannot be obtained during machining, the fourth type information in machining can be obtained by estimation as long as the second type information and the third type information are obtained during machining. Here, since the model used for estimation is generated using the extended third type information extended so that the uniformity is equal to or greater than the threshold value, the accuracy of the fourth type information estimated by the model can be even further enhanced. As such, according to the above generation method, a model for appropriately estimating information indicating machining results can be generated. Further, when estimating the fourth type information, it is not necessary to perform a new experiment using the fourth type information as an output variable. Therefore, there is an effect that an increase in the number of experiments for acquiring information that cannot be obtained during machining can be avoided in advance.

For example, a first relationship that is a relationship between the first type information, the second type information, and the third type information may be further derived, and the acquiring the extended plan information may include: acquiring the extended second type information by adding the new second type information to the second type information; acquiring the extended third type information by adding new third type information to the third type information; acquiring, by receiving the extended second type information and the extended third type information, the extended first type information using the first relationship; and acquiring the extended plan information including the extended first type information and the extended second type information.

According to the above aspect, since the extended first type information acquired using the extended second type information and the extended third type information is used, the extended plan information can be acquired more easily. As such, according to the above generation method, a model for appropriately estimating information indicating machining results can be more easily generated.

For example, the acquiring the extended plan information may include: determining whether or not the uniformity between the extended second type information and the extended third type information is equal to or greater than the threshold value; and acquiring the extended plan information when determining that the uniformity between the extended second type information and the extended third type information is equal to or greater than the threshold value.

According to the above aspect, by determining that the uniformity between the extended second type information and the extended third type information is equal to or greater than the threshold value, the extended third type information in which the uniformity is equal to or greater than the threshold value can be more easily acquired. As such, according to the above generation method, a model for appropriately estimating information indicating machining results can be more easily generated.

For example, the acquiring the extended plan information may include acquiring the extended plan information by adding new third type information to the third type information to add the new first type information belonging to a range from a minimum value to a maximum value in the first type information.

According to the above aspect, the new first type information added by adding the third type information belongs to a range in which the first type information indicating machining conditions is distributed. Therefore, the new first type information belongs to an appropriate range as machining conditions. In other words, deviation of the new first type information from the appropriate range as machining conditions is avoided. As a result, the extended first relationship is even more appropriate, and the accuracy of the estimated fourth type information can be even further enhanced. As such, according to the above generation method, a model for more appropriately estimating information machining results can be generated.

For example, the acquiring the extended plan information may include: calculating the uniformity between the extended second type information and the extended third type information using an average predicted variance of evaluation plan information including the second type information and the third type information as factors; and acquiring the extended plan information using the calculated uniformity.

According to the above aspect, since the uniformity between the extended second type information and the extended third type information is evaluated by the average predicted variance, the uniformity between the extended second type information and the extended third type information can be more easily evaluated. As such, according to the above generation method, a model for estimating information indicating machining results can be generated.

For example, the acquiring the extended second type information and the acquiring the extended third type information may include acquiring the extended second type information and acquiring the extended third type information by D-optimal design for the evaluation plan information including the second type information and the third type information as factors.

According to the above aspect, since the extended second type information and the extended third type information are acquired by D-optimal design for the evaluation plan information including the extended second type information and the extended third type information as factors, more appropriate extended third type information can be more easily acquired. As such, according to the above generation method, a model for estimating information indicating machining results can be more easily generated.

For example, the extended first relationship may be expressed by an extended first expression that receives the extended first type information and the extended second type information and outputs the extended third type information, and the model may include an extended third expression derived from the extended first expression, the extended third expression receiving the second type information measured during the actual device machining and the third type information measured during the actual device machining and outputting the first type information.

According to the above aspect, the fourth type information can be obtained using the extended third expression derived from the extended first expression by deformation. As such, according to the above generation method, a model for appropriately estimating information indicating machining results can be more easily generated.

For example, the extended second relationship may be expressed by an extended second expression that receives the extended first type information and the extended second type information and outputs the extended fourth type information, and the model may further include a model including the extended second expression and acquiring the first type information output by the extended third expression and the fourth type information output by the extended second expression receiving the second type information measured during the actual device machining.

According to the above aspect, the extended first type information can be easily estimated by the extended third expression from the measured values of the second type information and the third type information, and the fourth type information can be estimated by the extended second expression from the estimated extended first type information and the measured value of the second type information. As such, according to the above generation method, a model for appropriately estimating information indicating machining results can be more easily generated.

For example, each of the first type information and the fourth type information may be information determined in advance as information that is not measured during the actual device machining, and each of the second type information and the third type information may be information determined in advance as information that is measured during the actual device machining.

According to the above aspect, when information indicating machining conditions includes information that is not measured and information indicating machining results includes information that is not measured, the information indicating machining results can be appropriately estimated. As such, according to the above generation method, a model for appropriately estimating information indicating machining results can be generated even when there is information that is not measured during machining.

For example, the machining may be laser welding, the first type information may include a gap width between plates to be welded in the laser welding, the second type information may include a laser scanning speed in the laser welding, the third type information may include a surface welding width of a laser welded portion in the laser welding, and the fourth type information may include an interface welding width of the laser-welded portion in the laser welding.

According to the above aspect, a model for appropriately estimating information indicating machining results in laser welding can be more easily generated.

An estimation method according to an aspect of the present disclosure is an estimation method including: inputting, to a model output by the generation method described above, the second type information measured during the actual device machining and the third type information measured during the actual device machining; and outputting, as estimation information obtained by estimating the fourth type result of the actual device machining, the fourth type information output from the model receiving the second type information and the third type information.

According to the above aspect, information indicating a result of machining can be appropriately estimated by inputting the second type information and the third type information obtained during machining to the model.

A generation device according to one aspect of the present disclosure includes a processor and memory connected to the processor, in which using the memory, the processor: acquires, by performing experimental device machining according to plan information including first type information indicating a first type condition of the experimental device machining and second type information indicating a second type condition of the experimental device machining, third type information indicating a third type result of the experimental device machining according to the plan information and fourth type information indicating a fourth type result of the experimental device machining according to the plan information; acquires extended plan information including extended first type information including new first type information added to the first type information and extended second type information including new second type information added to the second type information, in which a uniformity of the extended second type information and extended third type information obtained as the third type result of the experimental device machining performed according to the extended plan information is equal to or greater than a threshold value; acquires, by performing the experimental device machining according to the extended plan information, the extended third type information indicating the third type result of the experimental device machining according to the extended plan information and extended fourth type information indicating the fourth type result of the experimental device machining according to the extended plan information; derives an extended first relationship that is a relationship between the extended first type information, the extended second type information, and the extended third type information; derives an extended second relationship that is a relationship between the extended first type information, the extended second type information, and the extended fourth type information; generates a model for estimating the fourth type information indicating the fourth type result of actual device machining by receiving the second type information measured during the actual device machining and the third type information measured during the actual device machining and using the extended first relationship and the extended second relationship; and outputs the model.

According to this, similar effects to those of the above generation method are obtained.

An estimation device according to one aspect of the present disclosure is an estimation device including a processor and memory connected to the processor. Using the memory, the processor: inputs, to the model output by the generation device described above, the second type information measured during the actual device machining and the third type information measured during the actual device machining; and outputs, as estimation information obtained by estimating the fourth type result of the actual device machining, the fourth type information output from the model receiving the second type information and the third type information.

According to this, similar effects to those of the above estimation method are obtained.

These comprehensive or specific aspects may be achieved by a system, a device, an integrated circuit, a computer program, or a recording medium such as a computer-readable CD-ROM, and may be achieved by any combination of the system, the device, the integrated circuit, the computer program, or the recording medium.

An exemplary embodiment is specifically described below with reference to the drawings.

The exemplary embodiment described below provides a comprehensive or specific example. Numerical values, shapes, materials, constituent elements, arrangement positions and connection configurations of the constituent elements, steps, processing order of the steps, and the like shown in the following exemplary embodiment are just an example, and are not intended to limit the present disclosure. Furthermore, those constituent elements introduced in the following exemplary embodiment that are not recited in the independent claim representing the most superordinate concept are illustrated herein as optional constituent elements.

### Exemplary Embodiment

The present exemplary embodiment describes items such as a generation method which generates a model for appropriately estimating information indicating machining results.

First, a process of device machining is described. Here, a laser welding process in a manufacturing line is described as an example of device machining, but application of the present exemplary embodiment is not limited thereto.

In general, in the process of device machining, the quality of the machining is evaluated. The quality is evaluated by evaluating information indicating the quality of the device machining, more specifically, a physical quantity related to the quality of the device machining. However, a physical quantity is not necessarily measured as described above, and may not be measured.

For example, in the laser welding process in the manufacturing line, joint strength is given as one index for evaluating process quality. Supposing that the joint strength is measured in-line, there is an advantage that it may lead to control for preventing in advance defects in a product produced through the process.

However, joint strength is substantially difficult or impossible to measure in-line. Therefore, connection strength must be evaluated by a joint strength evaluation test performed off-line.

Joint strength is correlated with an interface melting area between the plates to be welded, and the interface melting area can be calculated from an interface welding width and a welding distance. Therefore, if the interface welding width between the plates can be estimated, evaluation of the joint strength can be achieved. However, in-line measurement of interface welding width is also not currently performed.

A system (also referred to as an estimation system) of the present exemplary embodiment enables evaluation of the quality of device machining by estimating information indicating the quality of device machining from measurable information among information indicating machining conditions and measurable information among information indicating machining results. According to this method, when information indicating the quality of device machining is not directly measured, the information can be obtained by estimation.

Hereinafter, a model generation method of generating a model for estimating information indicating the quality of device machining from information indicating machining conditions and information indicating machining results, and an estimation method of the information using the model is described.

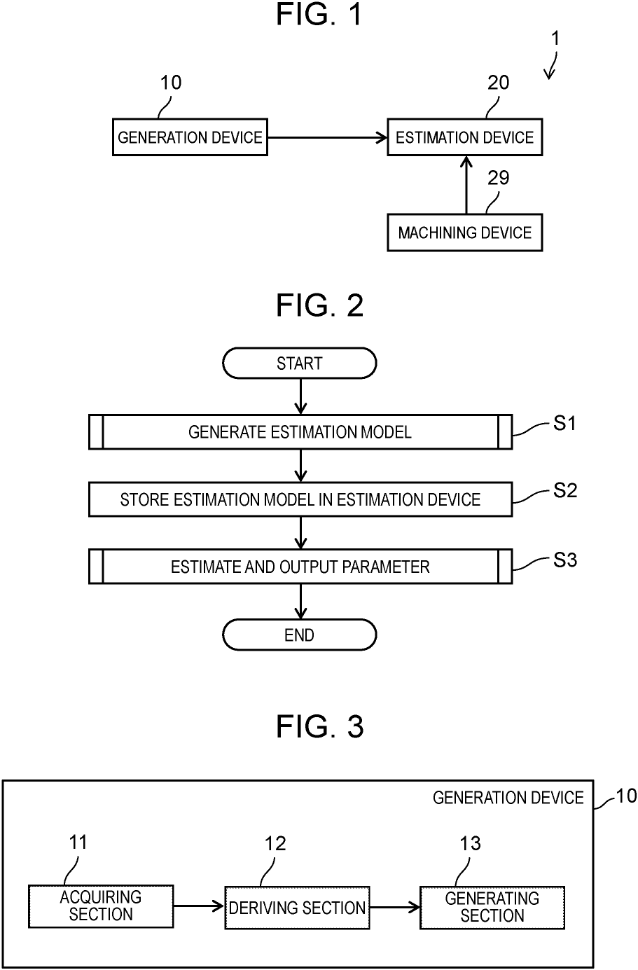

FIG. 1 is a descriptive diagram illustrating a configuration of system 1 according to the present exemplary embodiment.

As illustrated in FIG. 1, system 1 is an estimation system including generation device 10 and estimation device 20. Estimation device 20 is connected to machining device 29.

Generation device 10 is a device that generates a model for estimating information indicating device machining results. Generation device 10 generates a model (also referred to as an estimation model) for estimating information indicating device machining results based on information obtained by performing a device machining experiment with machining device 29. Generation device 10 provides the generated estimation model to estimation device 20. Generation device 10 performs the above processing off-line.

Estimation device 20 is a device that estimates information indicating device machining results. Estimation device 20 acquires the information indicating device machining conditions and the information indicating device machining results from machining device 29, and inputs the acquired information to the estimation model to estimate the information indicating device machining results. Estimation device 20 performs the above processing in-line.

Machining device 29 is a device that performs device machining. Specific examples of device machining include device laser welding and sputtering.

FIG. 2 is a descriptive diagram illustrating processing of system 1 according to the present exemplary embodiment.

In step S1 as illustrated in FIG. 2, generation device 10 generates an estimation model for estimating information indicating device machining results off-line. At this time, generation device 10 generates the estimation model using information obtained by performing a machining experiment.

In step S2, generation device 10 stores the estimation model generated in step S1 in estimation device 20.

In step S3, estimation device 20 uses the estimation model stored in step S2 to estimate information (parameters) indicating machining results in-line and outputs the information. At this time, estimation device 20 estimates the information using information obtained as a result of performing actual device machining.

Hereinafter, the configuration and processing of each of generation device 10 and estimation device 20 is described.

### Generation Device 10

FIG. 3 is a block diagram illustrating a functional configuration of generation device 10 according to the present exemplary embodiment.

As illustrated in FIG. 3, generation device 10 includes acquiring section 11, deriving section 12, and generating section 13 as functional sections. Generation device 10 can be achieved by a general computer device. Each functional section included in generation device 10 can be achieved by a processor (for example, a central processing unit (CPU), not illustrated) included in generation device 10 executing a program using memory (not illustrated).

Acquiring section 11 is a functional section that performs a device machining experiment and acquires a first parameter and a second parameter indicating machining conditions and a third parameter and a fourth parameter indicating machining results. The first parameter, the second parameter, the third parameter, and the fourth parameter are also referred to as first type information, second type information, third type information, and fourth type information, respectively. A device machining experiment is an experiment performed on the assumption that previous device machining has been performed, and is performed offline. The device machining experiment includes, for example, an actual machine experiment in which a process similar to a machining process in the manufacturing line is actually performed in another environment, or a simulation experiment in which a process simulating the machining process in the manufacturing line is performed by computer simulation.

In a case where the parameters are acquired by an actual machine experiment, acquiring section 11 may acquire results of the actual machine experiment performed in an experimental device different from generation device 10 from the device. At that time, acquiring section 11 may control the experimental device.

In a case where acquiring section 11 acquires the parameters through a simulation experiment, acquiring section 11 may perform the simulation experiment using the computer resources (processor, memory, etc.) included in generation device 10.

In addition, acquiring section 11 acquires experimental design model 105 including a set of parameters used in the experiment. Experimental design model 105 is used in an experiment for acquiring the third parameter and the fourth parameter.

Deriving section 12 is a functional section that derives a relationship between the first parameter, the second parameter, the third parameter, and the fourth parameter. Specifically, deriving section 12 derives a relationship (also referred to as a first relationship) between the first parameter, the second parameter, and the third parameter. Furthermore, deriving section 12 derives a relationship (also referred to as a second relationship) between the first parameter, the second parameter, and the fourth parameter.

Deriving section 12 also derives a relationship between an extended first parameter, an extended second parameter, an extended third parameter, and an extended fourth parameter obtained by extending the first parameter, the second parameter, the third parameter, and the fourth parameter, respectively. Specifically, deriving section 12 derives a relationship (also referred to as an extended first relationship) between the extended first parameter, the extended second parameter, and the extended third parameter. Additionally, deriving section 12 derives a relationship (also referred to as an extended second relationship) between the extended first parameter, the extended second parameter, and the extended fourth parameter.

Here, the extended first parameter is obtained by adding a new first parameter to the first parameter. The extended second parameter is obtained by adding a new second parameter to the second parameter. The extended third parameter is obtained by adding a new third parameter to the third parameter. The extended fourth parameter is obtained by adding a new fourth parameter to the fourth parameter.

When deriving the extended first relationship and the extended second relationship, deriving section 12 acquires an extended experimental model (also referred to as extended plan information) including the extended first parameter and the extended second parameter. The extended experimental model is an extended experimental model in which a uniformity of the extended second parameter and the extended third parameter obtained as a result of an experiment performed according to the extended experimental model is equal to or greater than a threshold value. Then, deriving section 12 performs an experiment according to the extended experimental model to acquire the extended third parameter and the extended fourth parameter indicating results of the experiment. Deriving section 12 derives the extended first relationship and the extended second relationship using the extended third parameter and the extended fourth parameter acquired in this manner.

The first relationship is expressed by, for example, a first statistical model expression (also referred to as a first expression) that outputs the third parameter with the first parameter and the second parameter as inputs. Furthermore, the second relationship is expressed by a second statistical model expression (also referred to as a second expression) that outputs the fourth parameter with the first parameter and the second parameter as inputs.

Similarly, the extended first relationship is expressed by, for example, an extended first statistical model expression (also referred to as an extended first expression) that outputs the extended third parameter with the extended first parameter and the extended second parameter as inputs. In addition, the extended second relationship is expressed by an extended second statistical model expression (also referred to as an extended second expression) that outputs the extended fourth parameter with the extended first parameter and the extended second parameter as inputs.

By extension of the first parameter and the like performed by deriving section 12, the uniformity of the second parameter and the third parameter can be improved. The first parameter and the second parameter included in experimental design model 105 can be predetermined to be sufficiently uniform. Here, the uniformity refers to a degree of uniformity. In addition, sufficiently uniform means that the uniformity of the distribution of the parameters within a range from a minimum value to a maximum value of the parameters is larger than the threshold value. In other words, the uniformity corresponds to the density of the parameters within the range being substantially uniform or the parameters being evenly present. The uniformity is evaluated using an average predicted variance, for example. The average predicted variance is an index indicating that the smaller the value, the larger the uniformity of the distribution (i.e., the distribution is even more uniform).

Conversely, it is not clear whether the third parameter obtained as a machining result is sufficiently uniform, and the third parameter may not be sufficiently uniform. In such a case, a new first parameter and second parameter are added to the first parameter and the second parameter included in experimental design model 105 so that the third parameter is sufficiently uniform, thereby extending the first parameter and the second parameter. In this manner, a sufficiently uniform third parameter is obtained by an experiment performed using the extended first parameter and second parameter. In this manner, by extending the first parameter and the like, the uniformity of the second parameter and the third parameter can be improved.

When acquiring the extended experimental model, deriving section 12 acquires the extended second parameter by adding a new second parameter to the second parameter. Furthermore, the extended third parameter is obtained by adding a new third parameter to the third parameter. Deriving section 12 acquires the extended first parameter using the extended third parameter and the first relationship. Then, deriving section 12 may acquire an extended experimental model including the acquired extended first parameter and extended second parameter.

When acquiring the extended experimental model, deriving section 12 may add a new third parameter to add a new first parameter belonging to a range from a minimum value to a maximum value among the first parameter, thereby acquiring an extended experimental model in which the uniformity of the second parameter and the third parameter is equal to or greater than the threshold value.

Generating section 13 is a functional section that receives, as inputs, the second parameter and the third parameter measured in-line during actual device machining by machining device 29 and generates and outputs an estimation model that is a model for estimating the fourth parameter indicating machining results. Generating section 13 estimates the fourth information using the extended first relationship and the extended second relationship based on the estimation model.

The estimation model includes an extended third statistical model expression (also referred to as an extended third expression) when the extended first relationship is expressed by the extended first statistical model expression and the extended second relationship is expressed by the extended second statistical model expression. The extended third statistical model expression is an expression derived from the extended first statistical model expression and which outputs the extended first parameter with the extended second parameter and the extended third parameter as inputs.

The estimation model includes the extended second statistical model expression together with the extended third statistical model expression. Then, the estimation model includes a model that acquires the first parameter output by the extended third statistical model expression with the second parameter and third parameter measured during machining as inputs and the fourth parameter output by the extended second statistical model expression with the second parameter measured during machining as an input.

The first parameter and the second parameter may be information determined in advance as information that is not measured during machining. Furthermore, the second parameter and the third parameter may be information determined in advance as information that is measured during machining. The information that is not measured during machining may include, for example, information that is technically possible to measure during machining but is not actually measured due to constraints such as cost or time required for measurement. In addition, the information that is not measured during machining may include information that is technically difficult or impossible to measure during machining.

Hereinafter, a generation method of the estimation model by deriving section 12 is described.

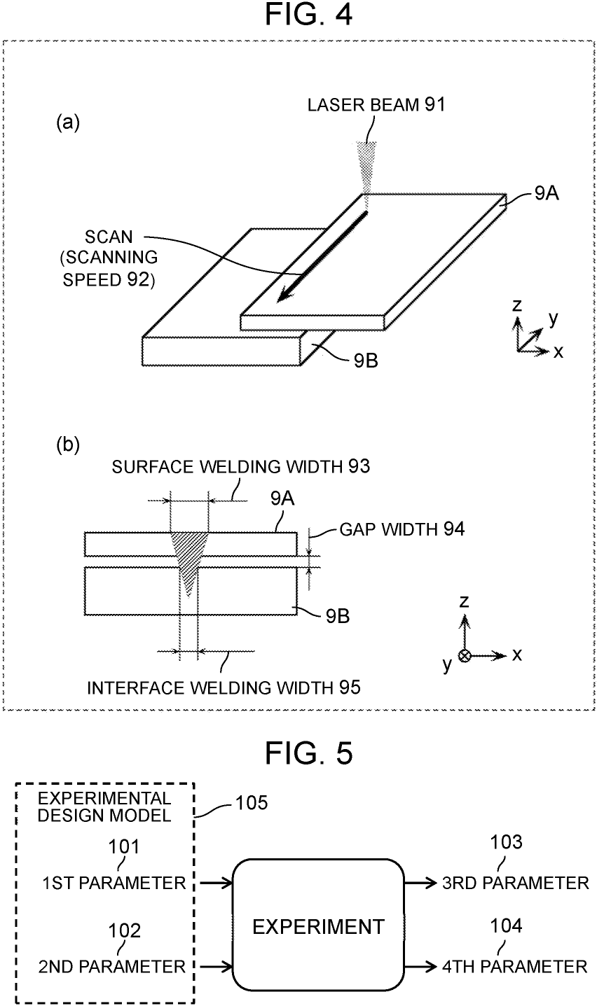

FIG. 4 is a descriptive diagram illustrating parameters related to a laser welding process. FIG. 5 is a descriptive diagram illustrating a relationship between the first to fourth parameters in an experiment according to the present exemplary embodiment. The first to fourth parameters are described with reference to FIGS. 4 and 5.

Part (a) of FIG. 4 schematically illustrates a state of a laser welding process in which machining device 29 welds plates 9A and 9B by laser welding. As illustrated in part (a) of FIG. 4, plates 9A and 9B are disposed so as to partially overlap each other. Machining device 29 irradiates a region where plates 9A and 9B overlap with each other while scanning the region with laser beam 91.

Part (b) of FIG. 4 schematically illustrates a state of a cross section of plates 9A and 9B welded by machining device 29 through laser welding. As illustrated in part (b) of FIG. 4, the portion of plates 9A and 9B irradiated by laser beam 91 is welded. In the welded portion of plates 9A and 9B, the width at the upper surface (i.e., a surface viewed from a positive Z axial direction) of plate 9A is also referred to as surface welding width 93, and the width at the interface between plates 9A and 9B is also referred to as interface welding width 95. In addition, there is a minute gap having gap width 94 between plates 9A and 9B.

Next, first to fourth parameters 101 to 104 and experimental design model 105 used for generating the estimation model will be described with reference to FIG. 5.

First parameter 101 is a parameter indicating machining conditions, and is a parameter for which in-line measurement is not performed due to cost, time constraints, or the like. First parameter 101 is a parameter necessary for estimating information indicating machining results with high accuracy.

First parameter 101 includes, for example, gap width 94 between plates 9A and 9B to be welded. Gap width 94 can be controlled by using a jig in an off-line experiment, and can be controlled by setting a simulation condition in a simulation experiment.

Second parameter 102 is a parameter indicating machining conditions, and is a parameter for which in-line measurement is performed. Second parameter 102 includes, for example, scanning speed 92 of the laser.

Experimental design model 105 is information including parameters (first parameter 101 and second parameter 102) used in the experiment. Experimental design model 105 is generated based on preset upper and lower limit values of values that can be taken by the respective first parameter 101 and second parameter 102 in the experiment. Experimental design model 105 includes setting information of values (also referred to as experimental point conditions) respectively taken by first parameter 101 and second parameter 102 in the experiment. As a result of performing the experiment under first parameter 101 and second parameter 102 set according to the experimental point condition indicated by experimental design model 105, third parameter 103 and fourth parameter 104 are output.

Third parameter 103 is information indicating machining conditions, and is a parameter for which in-line measurement is performed. Third parameter 103 includes, for example, surface welding width 93 of the laser welded portion.

Fourth parameter 104 is information indicating machining results, and is a parameter for which in-line measurement is not performed due to cost, time constraints, or the like. Fourth parameter 104 is a characteristic parameter related to machining quality. Fourth parameter 104 includes, for example, interface welding width 95 at the interface between plates 9A and 9B of the laser welded portion. In order to directly measure interface welding width 95, for example, there is a method of cutting a machined piece off-line and measuring the machined piece at the cut surface, but such measurement is difficult or impossible in-line.

Next, the first to third statistical model expressions, the extended first to third statistical model expressions, and the estimation model are described.

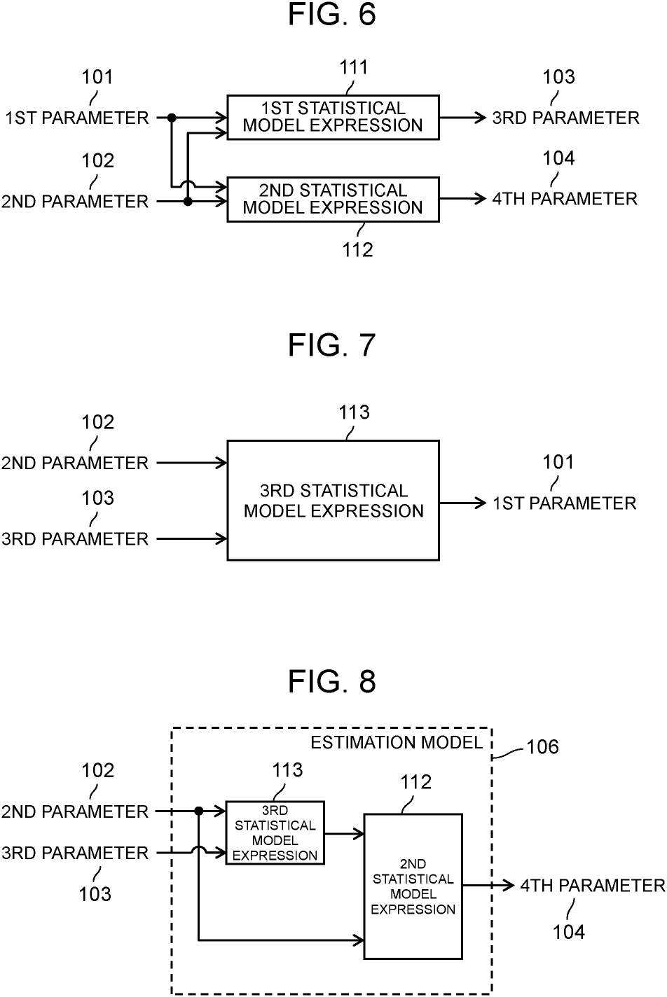

FIG. 6 is a descriptive diagram illustrating a relationship between the first to fourth parameters, the first statistical model expression, and the second statistical model expression derived by generation device 10 according to the present exemplary embodiment. FIG. 7 is a descriptive diagram illustrating a relationship between the first to third parameters and the third statistical model expression derived by generation device 10 according to the present exemplary embodiment. FIG. 8 is a descriptive diagram illustrating the estimation model generated by generation device 10 according to the present exemplary embodiment.

Deriving section 12 derives first statistical model expression 111 and second statistical model expression 112 by statistical modeling based on experimental design model 105 using the set of first to fourth parameters 101 to 104 obtained by the experiment. Here, first statistical model expression 111 is a model expression in which first parameter 101 and second parameter 102 are input variables (explanatory variables) and third parameter 103 is an output variable (objective variable). Furthermore, second statistical model expression 112 is a model expression in which first parameter 101 and second parameter 102 are input variables (explanatory variables) and fourth parameter 104 is an output variable (objective variable).

That is, first statistical model expression 111 and second statistical model expression 112 can be expressed in a form indicated in the following (Expression 1) (refer to FIG. 6).

First statistical model expression 111: third parameter = fi (first parameter, second parameter)

Second statistical model expression 112: fourth parameter = f₂ (first parameter, second parameter)

### Expression 1

Fourth parameter 104 is an objective variable used for machining evaluation, but fourth parameter 104 is a parameter for which in-line measurement is not performed and is estimated using second statistical model expression 112.

However, since first parameter 101, which is one input variable for second statistical model expression 112, is also a parameter for which in-line measurement is not performed, first parameter 101 also needs to be estimated.

Therefore, first statistical model expression 111 is used as a method of estimating first parameter 101. In first statistical model expression 111, first parameter 101 and second parameter 102 are input variables, and third parameter 103 is an output variable. By solving an algebraic equation with first parameter 101 as an unknown, first statistical model expression 111 can be converted into an expression with second parameter 102 and third parameter 103 as input variables and first parameter 101 as an output variable. Deriving section 12 obtains an expression (corresponding to third statistical model expression 113, refer to (Expression 2)) converted in this manner (refer to FIG. 7). Note that in deriving the third statistical model expression, appropriate restriction information is introduced in a case where the third statistical model expression cannot be defined without appropriate restriction information.

Third statistical model expression 113: first parameter = f₁⁻¹ (second parameter, third parameter)

### Expression 2

As such, first parameter 101 is derived by third statistical model expression 113 including second parameter 102 and third parameter 103.

Then, by substituting (Expression 2) into first parameter 101 in second statistical model expression 112 of (Expression 1) (i.e., setting both first parameter 101 and second parameter 102 as input variables), fourth parameter 104 can be estimated by second statistical model expression 112.

That is, fourth parameter 104 can be expressed in the following form (Expression 3) (refer to FIG. 8).

Fourth parameter = f₂(f₁⁻¹ (second parameter, third parameter), second parameter)

### Expression 3

A model that can output fourth parameter 104 when second parameter 102 and third parameter 103 are input in this manner is referred to as estimation model 106.

In a case where the uniformity of the second parameter and the third parameter is equal to or greater than the threshold value, the fourth parameter can be estimated with relatively high accuracy by estimation model 106 using (Expression 3) described above. Conversely, in a case where the uniformity of the second parameter and the third parameter is less than the threshold value, the accuracy of the fourth parameter estimated by estimation model 106 using (Expression 3) described above may be relatively low.

In this case, the fourth parameter having relatively high accuracy can be estimated using estimation model 106 derived using the extended first parameter or the like.

The extended first statistical model expression, the extended second statistical model expression, and the extended third statistical model expression can be expressed in a form indicated in the following (Expression 4) similarly to (Expression 1) and (Expression 2) described above.

Extended first statistical model expression: third parameter = gi(first parameter, second parameter)

Extended second statistical model expression: fourth parameter = g₂(first parameter, second parameter)

Extended third statistical model expression: first parameter = g₁⁻¹ (second parameter, third parameter)

### Expression 4

Then, fourth parameter 104 can be expressed in the form of (Expression 5) described below.

Fourth parameter = g₂(g₁⁻¹(second parameter, third parameter), second parameter)

### Expression 5

Note that g₁ is generally different from fi, but is not excluded from being the same as fi. Similarly, g₂ is generally different from f₂, but is not excluded from being the same as f₂.

Therefore, when second parameter 102 and third parameter 103 acquired by in-line measurement are input to estimation model 106, fourth parameter 104 as information indicating machining results that are a target of the in-line measurement can be estimated.

Processing of generation device 10 configured as above is described.

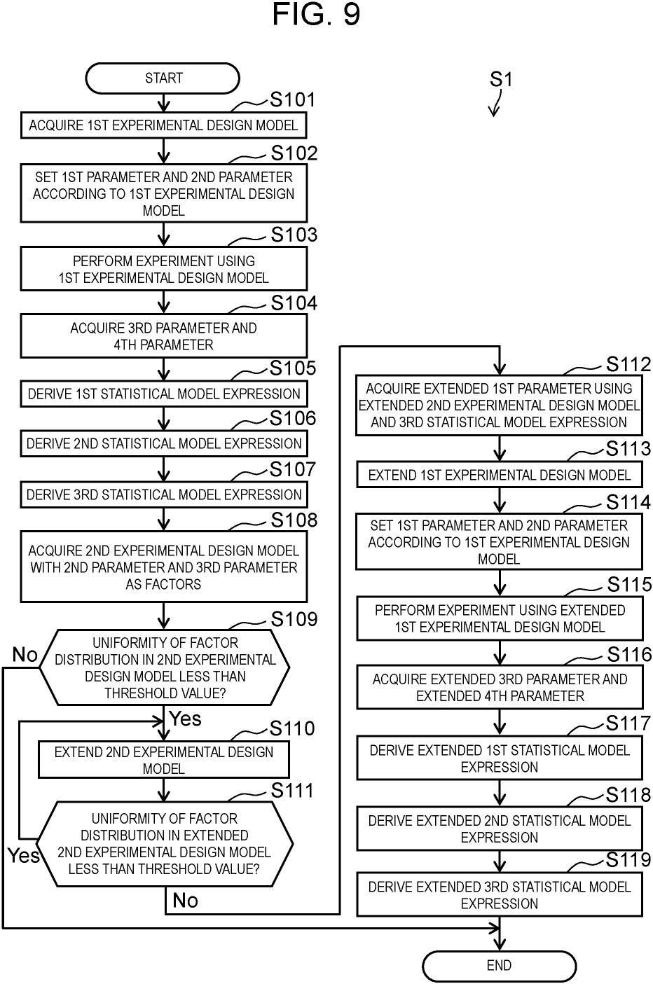

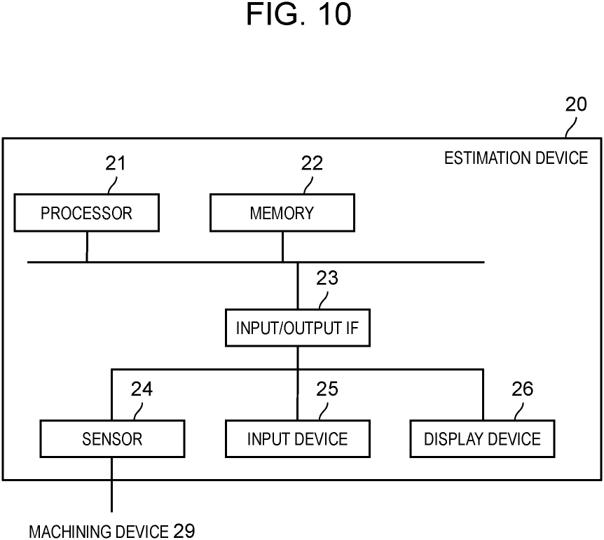

FIG. 9 is a flowchart illustrating processing performed by generation device 10 according to the present exemplary embodiment. The processing illustrated in FIG. 9 is processing included in step S1 of FIG. 2.

In step S101 as illustrated in FIG. 9, acquiring section 11 acquires experimental design model 105 (also referred to as a first experimental design model). The factors of the first experimental design model are the first parameter and the second parameter.

In step S102, acquiring section 11 sets the first parameter and the second parameter used in the experiment according to experimental design model 105 (first experimental design model) acquired in step S101.

In step S103, acquiring section 11 performs an experiment using experimental design model 105 (first experimental design model), that is, the first parameter and the second parameter set in step S102.

In step S104, acquiring section 11 acquires the third parameter and the fourth parameter output as a result of the experiment performed in step S103.

In step S105, deriving section 12 derives the first statistical model expression using the first parameter and the second parameter set in step S102 and the third parameter acquired in step S104.

In step S106, deriving section 12 derives the second statistical model expression using the first parameter and the second parameter set in step S102 and the fourth parameter acquired in step S104.

In step S107, deriving section 12 derives the third statistical model expression using the first statistical model expression derived in step S105 and the second statistical model expression derived in step S106.

In step S108, deriving section 12 acquires the second experimental design model. The factors of the second experimental design model are the second parameter that is a factor of the first experimental design model and the third parameter output as a result of the experiment performed in step S103.

In step S109, deriving section 12 determines whether or not the uniformity of the factors of the second experimental design model is less than a threshold value (also referred to as a first threshold value). Here, the uniformity of the factors of the second experimental design model is an index indicating the uniformity of the distribution of the factors of the second experimental design model, and is an index indicating that the larger the value, the higher the uniformity (i.e., the distribution is even more uniform). More specifically, the factors of the second experimental design model are the extended second parameter and the extended third parameter included in the second experimental design model. When it is determined that the uniformity of the factors of the second experimental design model is less than the first threshold value (Yes in step S109), the processing proceeds to step S110. Otherwise (No in step S109), the series of processing illustrated in FIG. 9 is ended.

The uniformity of the factors of the second experimental design model is evaluated using an average predicted variance, for example. In this case, when a value obtained by dividing the average predicted variance of the factors of the second experimental design model by the average predicted variance of the factors of the first experimental design model falls below a threshold value (also referred to as a second threshold value), the uniformity of the factors of the second experimental design model is less than the first threshold value.

The inventors of the present application have found that the second threshold value can be set to a numerical value within a range from 1 to 2, for example, and can be more specifically set to 1.05.

In step S110, deriving section 12 extends the second experimental design model. Deriving section 12 extends the second experimental design model by adding a group of the second parameter and the third parameter to the factors of the second experimental design model. At this time, the group of the second parameter and the third parameter, which satisfies a condition that the first parameter output by inputting the added group of the second parameter and the third parameter to first statistical model expression 111 belongs to a range from a minimum value to a maximum value among a plurality of first parameters included in the first experimental design model, is added to the factors of the second experimental design model. That is, deriving section 12 acquires the second experimental design model in which the uniformity of the factors is greater than or equal to the first threshold value such that the added first parameter belongs to the range from the minimum value to the maximum value among the plurality of first parameters included in the first experimental design model.

In other words, deriving section 12 obtains the extended second experimental design model by adding a group of the second parameter and the third parameter satisfying a condition (also referred to as a constraint condition) indicated in (Expression 6) described below to the second experimental design model.

Maximum value (first parameter in first experimental design model)

≥ f₁⁻¹ (second parameter, third parameter); and

Minimum value (first parameter in first experimental design model)

≤ f₁⁻¹ (second parameter, third parameter) (Expression 6)

There are various determination methods for the added group of the second parameter and the third parameter. Specific examples include D-optimal design and I-optimal design. I-optimal design is a determination method for minimizing the prediction variance in all the design areas. D-optimal design is a determination method focusing on reducing the prediction variance at each design point. The inventors of the present application have found that a second parameter and a third parameter having higher uniformity are obtained by adopting D-optimal design than I-optimal design.

In step S111, deriving section 12 determines whether or not the uniformity of the factors of the second experimental design model extended in step S110 is less than the first threshold value. When it is determined that the uniformity of the factors of the second experimental design model is less than the first threshold value (Yes in step S111), step S110 is performed again. Otherwise (No in step S111), the processing proceeds to step S112. Proceeding to step S112 corresponds to a case where the uniformity of the distribution of the factors of the second experimental design model becomes equal to or greater than the first threshold value by performing the extension of the second experimental design model described above (step S110) once or more.

In step S112, deriving section 12 acquires the extended first parameter using the extended second experimental design model and the third statistical model expression.

In step S113, deriving section 12 extends the first experimental design model using the extended first parameter acquired in step S112.

In step S114, deriving section 12 sets the first experimental design model extended in step S113, that is, the extended first parameter and the extended second parameter as the first parameter and the second parameter used in the experiment.

In step S115, deriving section 12 performs an experiment using the first experimental design model extended in step S113, that is, the extended first parameter and the extended second parameter.

In step S116, deriving section 12 acquires the third parameter and the fourth parameter output as a result of the experiment performed in step S115 as the respective extended third parameter and extended fourth parameter.

In step S117, deriving section 12 derives the first statistical model expression (also referred to as the extended first statistical model expression) using the extended first parameter and the extended second parameter set in step S114 and the extended third parameter acquired in step S116 (refer to (Expression 4) described above).

In step S118, deriving section 12 derives the second statistical model expression (also referred to as the extended second statistical model expression) using the extended first parameter and the extended second parameter set in step S114 and the extended fourth parameter acquired in step S116 (refer to (Expression 4) described above).

In step S119, deriving section 12 derives the third statistical model expression (extended third statistical model expression) using the extended first statistical model expression derived in step S117 and the extended second statistical model expression derived in step S118 (refer to (Expression 4) described above).

Through the series of processing illustrated in FIG. 9, a model for appropriately estimating information indicating machining results can be generated.

### Estimation Device 20

Next, estimation device 20 is described.

FIG. 10 is a block diagram illustrating a hardware configuration of estimation device 20 according to the present exemplary embodiment.

Estimation device 20 is achieved by a computer, for example, and includes processor 21, memory 22, input/output interface (IF) 23, sensor 24, input device 25, and display device 26.

Processor 21 is an arithmetic device that performs parameter estimation processing, and is a CPU, for example.

Memory 22 is a storage device that stores programs or data, and is random-access memory (RAM), for example. Estimation model 106 generated by generation device 10 is stored in memory 22.

Input/output IF 23 is an interface device that transfers data between processor 21, memory 22, sensor 24, input device 25, and display device 26. Input/output IF 23 is connected to each of the above devices. The connection is wired or wireless, and may be a combination thereof.

Sensor 24 is installed in machining device 29 to be subjected to in-line measurement. Machining device 29 is a laser welding device, for example. Sensor 24 is, for example, a laser displacement meter that measures surface welding width 93 (refer to part (b) of FIG. 4) of plates to be welded.

Input device 25 is a device that receives input of information regarding the first to fourth parameters, and is a keyboard or a touch panel, for example.

Display device 26 is a device that indicates information related to the first to fourth parameters, and is a liquid-crystal display (LCD) monitor, for example.

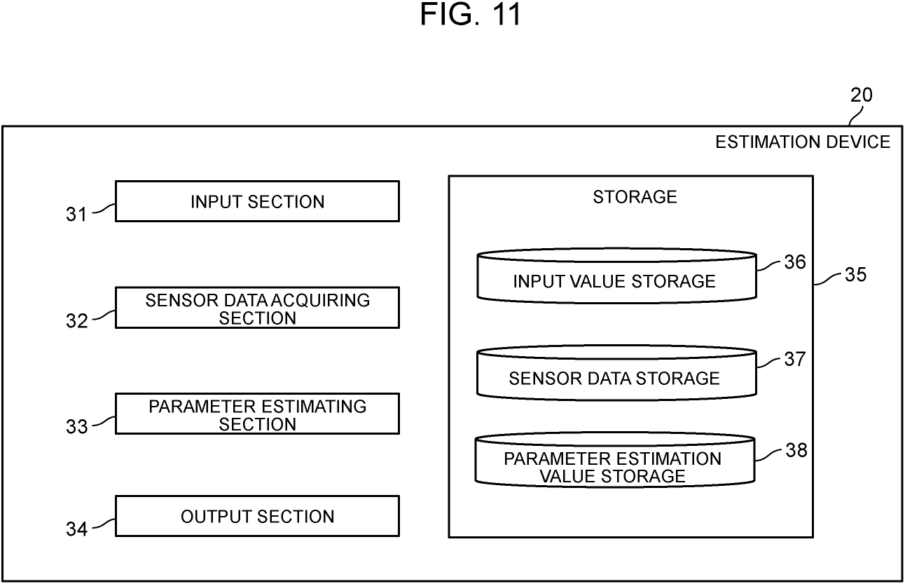

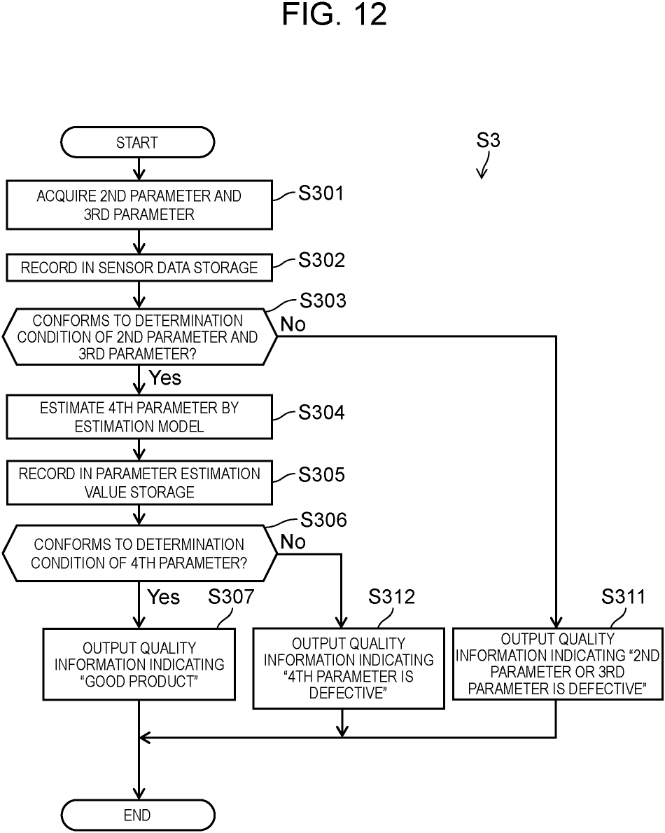

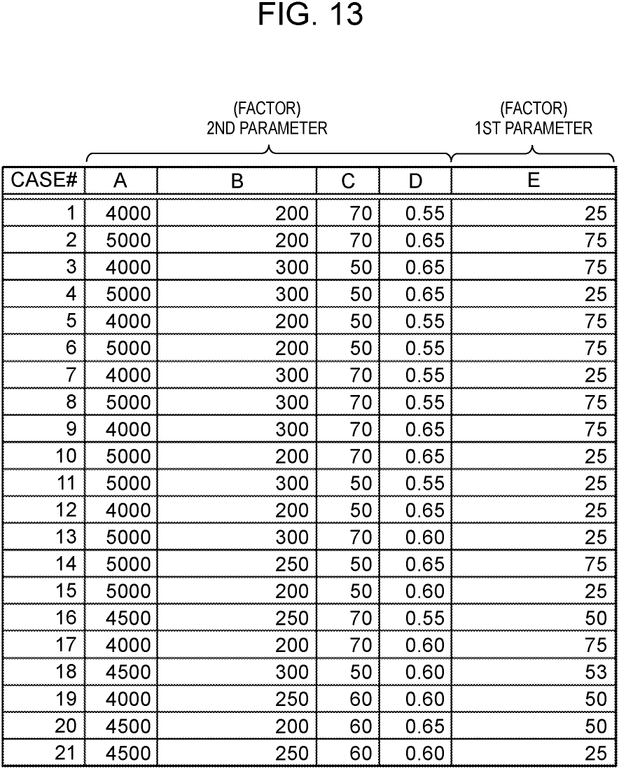

FIG. 11 is a block diagram illustrating a functional configuration of estimation device 20 according to the present exemplary embodiment.

As illustrated in FIG. 11, estimation device 20 includes input section 31, sensor data acquiring section 32, parameter estimating section 33, output section 34, and storage 35 as a functional configuration.

Input section 31 is a functional section that receives input of determination value information such as standard values related to first parameter 101, second parameter 102, third parameter 103, and fourth parameter 104 from a user via input device 25. The input timing is when the unit type of machining device 29 is switched, for example, but is not limited thereto. Here, the input value is registered in input value storage 36 of storage 35.

Sensor data acquiring section 32 is a functional section that acquires measurement data of second parameter 102 and third parameter 103 from sensor 24 connected to machining device 29. Second parameter 102 is, for example, scanning speed 92 (refer to part (a) of FIG. 4). Third parameter 103 is, for example, surface welding width 93 of the plates to be welded (refer to part (b) of FIG. 4). A data acquisition frequency can be arbitrarily set, but in the subsequent parameter estimation, sequentially acquired data may be used each time, or an average value may be calculated from a plurality of pieces of data acquired for one workpiece, and the average value may be used as a representative value of the workpiece. The acquired data is recorded in sensor data storage 37. In addition, it is determined whether or not the acquired data conforms to a determination condition stored in input value storage 36. In a case where the acquired data does not conform to the determination condition, quality information indicating a defect (NG) is output. The determination condition is, for example, a condition indicating a standard value or a condition indicating a normal range.

Parameter estimating section 33 estimates fourth parameter 104 by inputting second parameter 102 and third parameter 103 recorded in sensor data storage 37 to estimation model 106 (i.e., using (Expression 3) described above). Fourth parameter 104 is, for example, interface welding width 95 between plates (refer to part (b) of FIG. 4). The calculated estimated value of fourth parameter 104 is recorded in parameter estimated value storage 38. In addition, it is determined whether or not the calculated estimated value of fourth parameter 104 conforms to the determination condition stored in input value storage 36. In a case where the calculated estimated value does not conform to the determination condition, quality information indicating a defect (NG) is output. The determination condition is, for example, a condition indicating a standard value or a condition indicating a normal range.

Output section 34 is a functional section that outputs data recorded in storage 35 or a determination result. Output section 34 outputs the data and the like by displaying the data and the like on display device 26, for example. Note that output section 34 may output the data and the like by voice or may output the data and the like by transmitting the data and the like to another device by communication.

Storage 35 is a functional section that stores various values and various data. Storage 35 includes input value storage 36, sensor data storage 37, and parameter estimated value storage 38. In storage 35, values or data are stored or read by the functional sections.

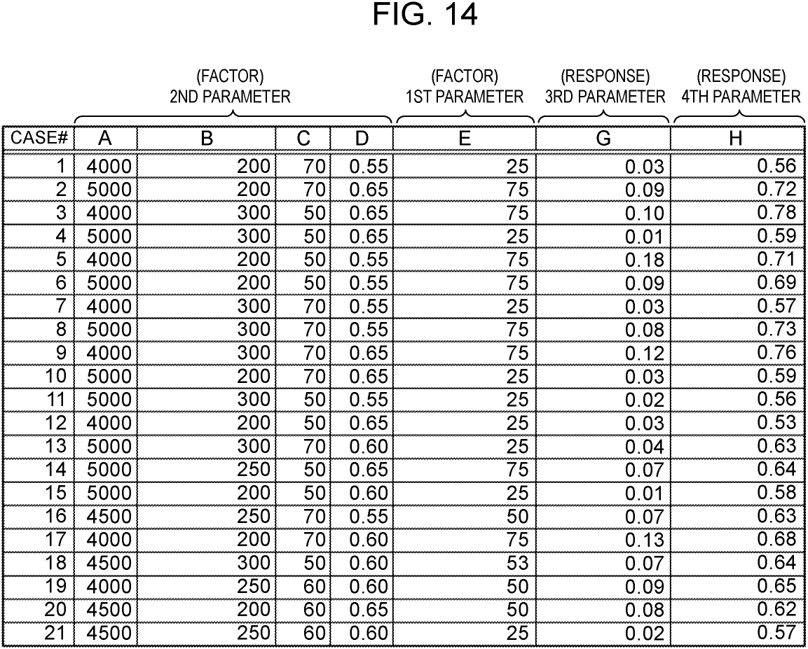

FIG. 12 is a flowchart illustrating processing performed by estimation device 20 according to the present exemplary embodiment. The processing illustrated in FIG. 12 is processing included in step S3 of FIG. 2.

In step S301, sensor data acquiring section 32 acquires measurement data of second parameter 102 and third parameter 103 from sensor 24.

In step S302, sensor data acquiring section 32 stores the measurement data acquired in step S301 in sensor data storage 37.

In step S303, sensor data acquiring section 32 determines whether or not the measurement data acquired in step S301 conforms to the determination condition. When the measurement data conforms to the determination condition (Yes in step S303), step S304 is performed. When the measurement data does not conform to the determination condition (No in step S303), step S311 is performed.

In step S304, parameter estimating section 33 estimates fourth parameter 104 by inputting second parameter 102 and third parameter 103 which are measurement data recorded in sensor data storage 37 to estimation model 106 (i.e., using (Expression 3) described above).

In step S305, parameter estimating section 33 stores fourth parameter 104 estimated in step S304 in parameter estimated value storage 38.

In step S306, parameter estimating section 33 determines whether or not fourth parameter 104 estimated in step S304 conforms to the determination condition. When conforming to the determination condition (Yes in step S306), step S307 is performed. When not conforming to the determination condition (No in step S306), step S312 is performed.

In step S307, output section 34 outputs quality information indicating a good product (OK).

In step S311, output section 34 outputs quality information indicating a defect (NG) based on the fact that second parameter 102 or third parameter 103 does not conform to the determination condition.

In step S312, output section 34 outputs quality information indicating a defect (NG) based on the fact that fourth parameter 104 does not conform to the determination condition.

Upon completion of the processing in step S307, S311, or S312, the series of processing illustrated in FIG. 12 is ended.

Through the series of processing illustrated in FIG. 12, for example, in the laser welding process, interface welding width 95 between the plates can be estimated in-line based on measurement data measured in-line such as scanning speed 92 of the laser or surface welding width 93 of the laser welded portion. Supposing that interface welding width 95 is to be measured, it is necessary to observe a cross-sectional shape off-line, but there is an effect that interface welding width 95 can be estimated in-line.

Hereinafter, examples of the accuracy of estimation by the first experimental design model, the second experimental design model, and the estimation model are described.

FIG. 13 is a descriptive diagram illustrating an example of the first experimental design model acquired by generation device 10 according to the present exemplary embodiment.

FIG. 13 illustrates parameters A, B, C, D, and E indicating device machining conditions (also referred to as factors) for each of 21 cases as the first experimental design model. Here, parameters A, B, C, and D correspond to the second parameter, and parameter E corresponds to the first parameter.

The first experimental design model illustrated in FIG. 13 is an example of the first experimental design model acquired by acquiring section 11 in step S101 (refer to FIG. 9).

FIG. 14 is a descriptive diagram illustrating an example of results of an experiment performed according to the first experimental design model according to the present exemplary embodiment.

FIG. 14 illustrates parameters G and H indicating the results (also referred to as responses) of a machining experiment using parameters A, B, C, D, and E illustrated in FIG. 13 for each of the 21 cases. Here, parameter G corresponds to the third parameter, and parameter H corresponds to the fourth parameter.

The third parameter and the fourth parameter illustrated in FIG. 14 are examples of the third parameter and the fourth parameter acquired by acquiring section 11 in step S104 (refer to FIG. 9).

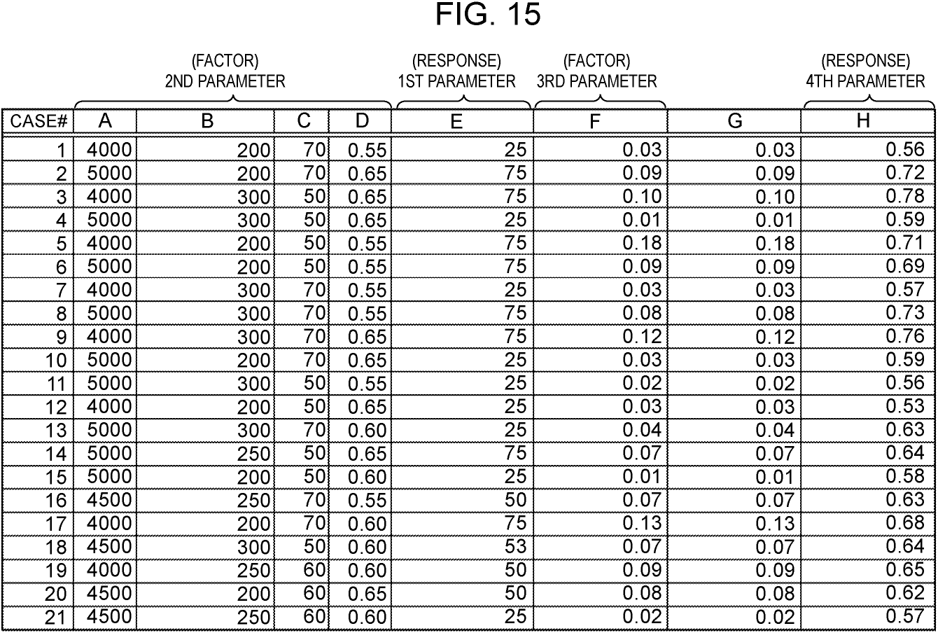

FIG. 15 is a descriptive diagram illustrating an example of the second experimental design model acquired by the generation device according to the present exemplary embodiment.

In the second experimental design model illustrated in FIG. 15, the second parameter (i.e., parameters A, B, C and D) and the third parameter (i.e., parameter F) illustrated in FIG. 14 are set as factors, and the first parameter (i.e., parameter E) and the fourth parameter (i.e., parameter H) are set as responses.

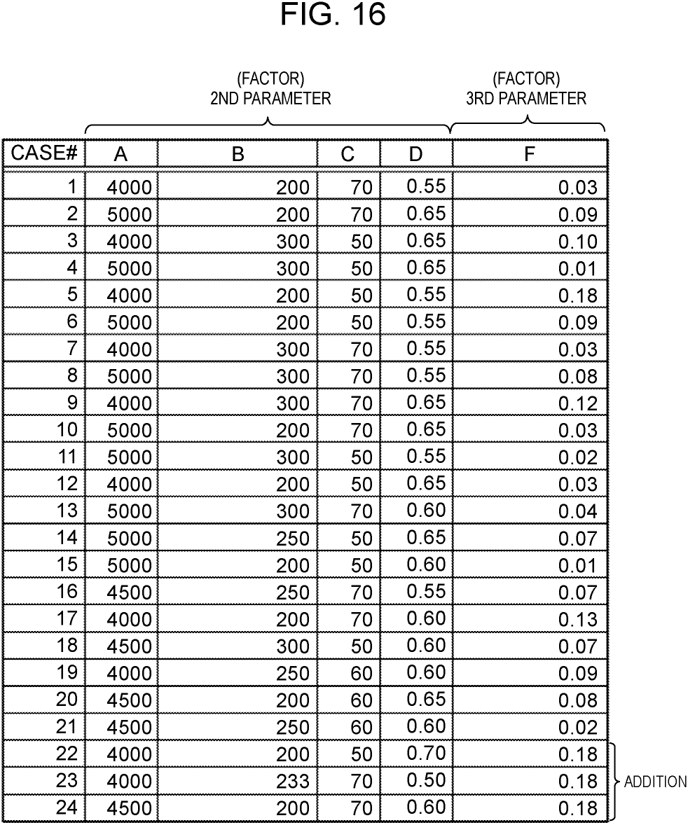

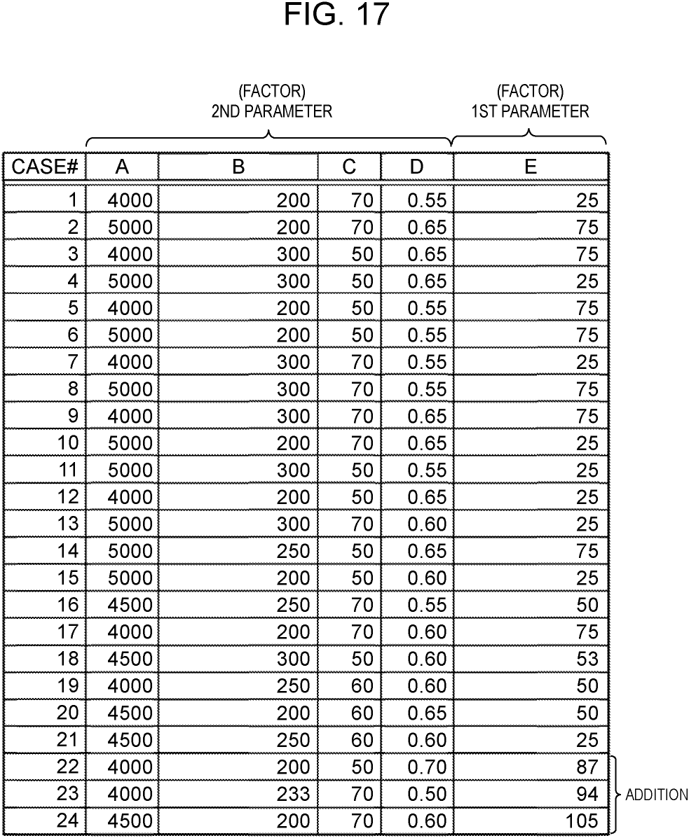

FIG. 16 is a descriptive diagram illustrating an example of extension of the second experimental design model acquired by the generation device according to the present exemplary embodiment.

FIG. 16 illustrates first to fourth parameters for 24 cases.

Specifically, for the 21 cases 1 to 21 in FIG. 16, the second parameter (i.e., parameters A, B, C and D) and the third parameter (i.e., parameter F) illustrated in FIG. 15 are included as factors.

In addition, for the 3 cases 22 to 24 in FIG. 16, the second parameter and the third parameter added so that the uniformity of the factors (i.e., the second parameter and the third parameter) of the second experimental design model is greater than or equal to the first threshold value are included (steps S110 and S111).

In other words, the second experimental design model illustrated in FIG. 16 is an example of the second experimental design model extended once or more by deriving section 12 in steps S110 and S111 (refer to FIG. 9).

FIG. 17 is a descriptive diagram illustrating an example of extension of the first experimental design model according to the present exemplary embodiment.

For the 21 cases 1 to 21 in FIG. 17, the first parameter and the second parameter illustrated in FIG. 13 are illustrated.

For the 3 cases 22 to 24 in FIG. 17, the second parameter added to the second experimental design model and the first parameter calculated by the first statistical model expression from the second parameter and the third parameter added to the second experimental design model are illustrated.

The extended first experimental design model illustrated in FIG. 17 is an example of the first experimental design model extended by deriving section 12 in step S113 (refer to FIG. 9).

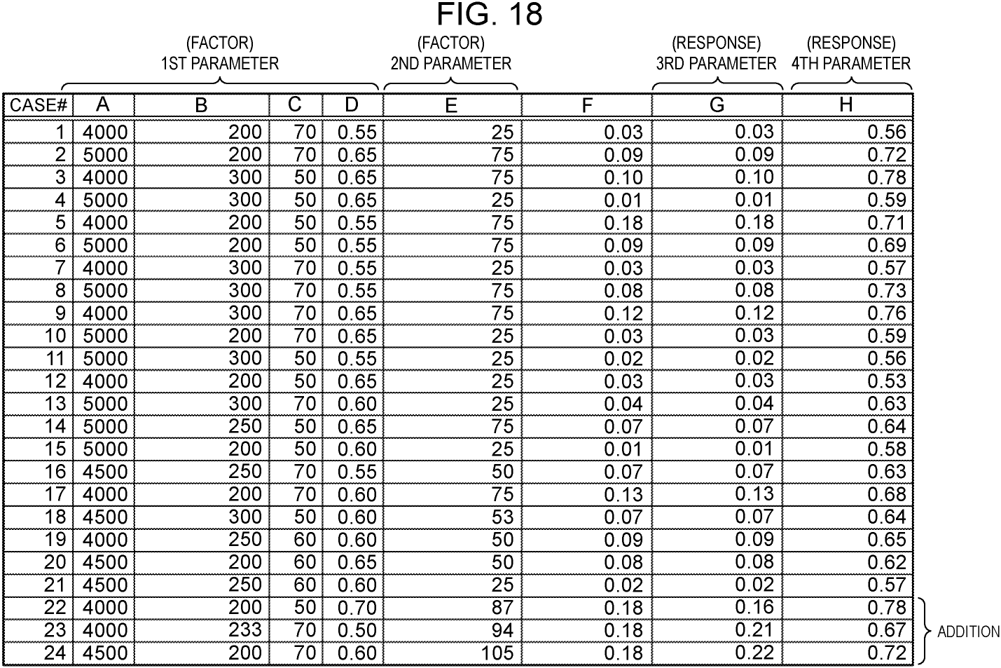

FIG. 18 is a descriptive diagram illustrating an example of results of an experiment performed according to the extended first experimental design model according to the present exemplary embodiment.

For the 21 cases 1 to 21 in FIG. 18, the first to fourth parameters illustrated in FIG. 14 are illustrated.

In addition, for the 3 cases 22 to 24 in FIG. 18, the third parameter and the fourth parameter acquired through an experiment performed by setting the first parameter and the second parameter added to the second experimental design model are illustrated.

The third parameter and the fourth parameter illustrated in FIG. 18 are examples of the extended third parameter and the extended fourth parameter acquired by deriving section 12 in step S116 (refer to FIG. 9).

Then, the extended first statistical model expression, the extended second statistical model expression, and the extended third statistical model expression are derived by deriving section 12 using the first to fourth parameters illustrated in FIG. 18 (steps S117 to S119).

FIG. 19 is a descriptive diagram illustrating an example of estimation accuracy of the estimation model according to the present exemplary embodiment.

FIG. 19 illustrates a graph in which measured values (vertical axis, “H measured values”) are plotted with respect to estimated values (horizontal axis, denoted as “H estimated values”) for parameter H which is the fourth parameter in the 24 cases illustrated in FIG. 18 and the like.

Here, results based on the estimated values obtained from the estimation model generated using the first parameter and the second parameter included in the first experimental design model before extension are indicated by black circles. These correspond to the 21 cases 1 to 21 in FIG. 18.

Results based on the estimated values obtained from the estimation model generated using the added first parameter and the added second parameter included in the extended first experimental design model are indicated by white circles. These correspond to the 3 cases 22 to 24 in FIG. 18.

The root-mean-square error (RMSE) of the estimated values and measurement values obtained from the estimation model generated using the added first parameter and the added second parameter included in the first experimental design model before extension is 0.0274.

The RMSE of the estimated values and measurement values obtained from the estimation model generated using the added first parameter and the added second parameter included in the extended first experimental design model is 0.0277.

As such, the extension of the first experimental design model improves the estimation accuracy of parameter H by the estimation model.

### Variation

A variation of the generation method and the estimation method which generate a model for appropriately estimating information indicating machining results in the present exemplary embodiment is described.

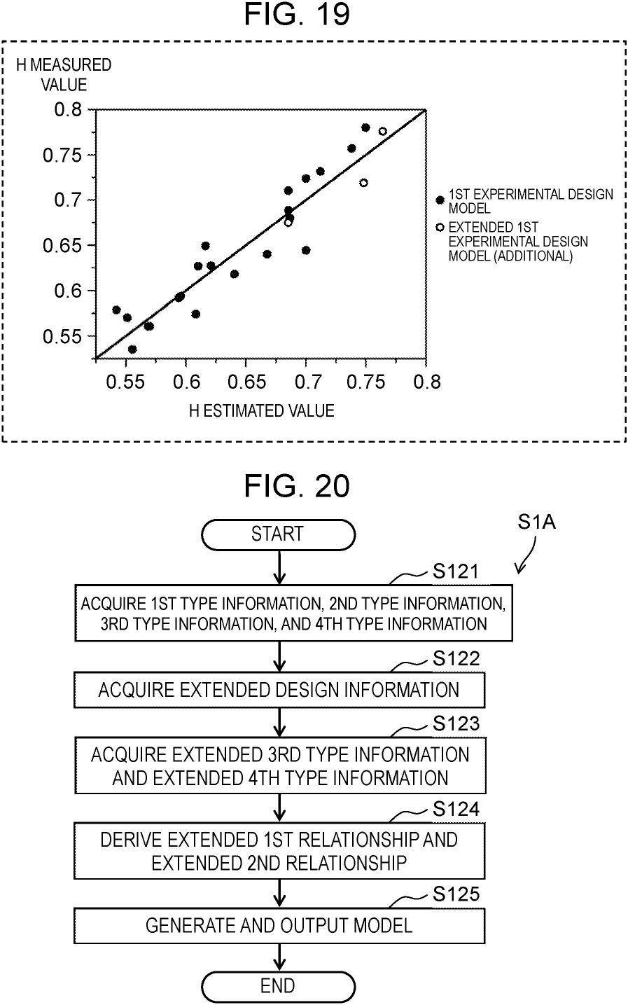

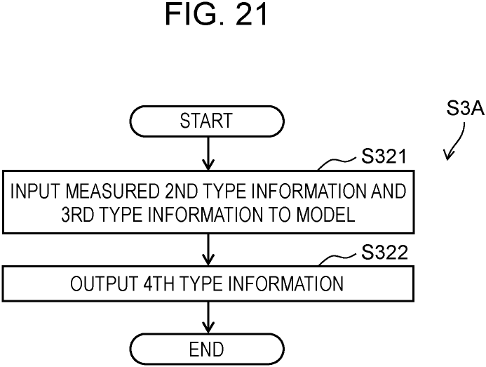

FIG. 20 is a flowchart illustrating processing (i.e., a generation method) performed by a generation device according to the present variation. The processing illustrated in FIG. 20 is another example of the processing included in step S1 of FIG. 2.

In step S121 as illustrated in FIG. 20, the generation device acquires the third type information and the fourth type information indicating the results of a machining experiment by performing the machining experiment according to plan information including the first type information and the second type information indicating the device machining conditions.

In step S122, the generation device acquires extended plan information including extended first type information in which new first type information has been added to the first type information and extended second type information in which new second type information has been added to the second type information, and in which a uniformity of the extended second type information and extended third type information obtained as a result of a machining experiment performed according to the extended plan information is equal to or greater than a threshold value.

In step S123, the generation device acquires the extended third type information and the extended fourth type information indicating the results of a machining experiment by performing the machining experiment according to the extended plan information.

In step S124, the generation device derives an extended first relationship that is a relationship between the extended first type information, the extended second type information, and the extended third type information, and derives an extended second relationship that is a relationship between the extended first type information, the extended second type information, and the extended fourth type information.

In step S125, the generation device generates and outputs a model for estimating the fourth type information indicating machining results using the extended first relationship and the extended second relationship with the second type information and the third type information measured during device machining as inputs.

Through the above, the generation device can generate a model for appropriately estimating information indicating machining results.

FIG. 21 is a flowchart illustrating processing (i.e., an estimation method) performed by an estimation device according to the present variation. The processing illustrated in FIG. 21 is another example of processing included in step S3 of FIG. 2.

In step S321, the estimation device inputs the second type information and the third type information measured during machining to the model output by the generation device described above.

In step S322, the estimation device outputs the fourth type information output by inputting the second type information and the third type information as estimation information estimating machining results.

Through the above, the estimation device can estimate information indicating machining results using a model for appropriately estimating information indicating the machining results.

According to the generation method of the present exemplary embodiment described above, it is possible to obtain a model for estimating the fourth type information in machining from the second type information and the third type information obtained during machining using the relationship between the first type information, the second type information, the third type information, and the fourth type information obtained from the experiment. By using this model, even when the fourth type information cannot be obtained during machining, the fourth type information in machining can be obtained by estimation as long as the second type information and the third type information are obtained during machining. Here, since the model used for estimation is generated using the extended third type information extended so that the uniformity is equal to or greater than the threshold value, the accuracy of the fourth type information estimated by the model can be even further enhanced. As such, according to the above generation method, a model for appropriately estimating information indicating machining results can be generated. Further, when estimating the fourth type information, it is not necessary to perform a new experiment using the fourth type information as an output variable. Therefore, there is an effect that an increase in the number of experiments for acquiring information that cannot be obtained during machining can be avoided in advance.

Furthermore, since the extended first type information acquired using the extended second type information and the extended third type information is used, the extended plan information can be acquired more easily. As such, according to the above generation method, a model for appropriately estimating information indicating machining results can be more easily generated.

In addition, by determining that the uniformity of the extended second type information and the extended third type information is equal to or greater than the threshold value, the extended third type information in which the uniformity is equal to or greater than the threshold value can be more easily acquired. As such, according to the above generation method, a model for appropriately estimating information indicating machining results can be more easily generated.

Furthermore, new first type information added by adding the third type information belongs to the range in which first type information indicating machining conditions is distributed. Therefore, the new first type information belongs to an appropriate range as machining conditions. In other words, deviation of the new first type information from the appropriate range as machining conditions is avoided. As a result, the extended first relationship is even more appropriate, and the accuracy of the estimated fourth type information can be even further enhanced. As such, according to the above generation method, a model for more appropriately estimating information machining results can be generated.

In addition, since the uniformity between the extended second type information and the extended third type information is evaluated by an average predicted variance, the uniformity between the extended second type information and the extended third type information can be more easily evaluated. As such, according to the above generation method, a model for estimating information indicating machining results can be generated.

Furthermore, since the extended second type information and the extended third type information are acquired by D-optimal design for the evaluation plan information including the extended second type information and the extended third type information as factors, more appropriate extended third type information can be more easily acquired. As such, according to the above generation method, a model for estimating information indicating machining results can be more easily generated.

In addition, fourth type information can be obtained using an extended third expression derived from the extended first expression by deformation. As such, according to the above generation method, a model for appropriately estimating information indicating machining results can be more easily generated.

Furthermore, the extended first type information can be easily estimated by the extended third expression from the measured values of the second type information and the third type information, and the fourth type information can be estimated by the extended second expression from the estimated extended first type information and the measured value of the second type information. As such, according to the above generation method, a model for appropriately estimating information indicating machining results can be more easily generated.

In addition, when information indicating machining conditions includes information that is not measured and information indicating machining results includes information that is not measured, the information indicating the machining results can be appropriately estimated. As such, according to the above generation method, a model for appropriately estimating information indicating machining results can be generated even when there is information that is not measured during machining.

Furthermore, a model for appropriately estimating information indicating machining results in laser welding can be more easily generated.

In addition, according to the estimation method of the present exemplary embodiment, information indicating machining results can be appropriately estimated by inputting the second type information and the third type information obtained during machining to the model.

In the above-described exemplary embodiment, each constituent element may be configured with dedicated hardware or may be achieved by executing a software program suitable for the constituent elements. Each constituent element may be achieved by a program executor such as a CPU or a processor reading and executing a software program recorded in a recording medium such as a hard disk or semiconductor memory. Here, software that achieves the generation device and the estimation device according to the exemplary embodiment described above includes the following program.

That is, the program executes a generation method executed on a computer by a processor using memory. The generation method includes: acquiring, by performing experimental device machining according to plan information including first type information indicating a first type condition of the experimental device machining and second type information indicating a second type condition of the experimental device machining, third type information indicating a third type result of the experimental device machining according to the plan information and fourth type information indicating a fourth type result of the experimental device machining according to the plan information; acquiring extended plan information including extended first type information including new first type information added to the first type information and extended second type information including new second type information added to the second type information, in which a uniformity of the extended second type information and extended third type information acquired as the third type result of the experimental device machining performed according to the extended plan information is equal to or greater than a threshold value; acquiring, by performing the experimental device machining according to the extended plan information, the extended third type information indicating the third type result of the experimental device machining according to the extended plan information and extended fourth type information indicating the fourth type result of the experimental device machining according to the extended plan information; deriving an extended first relationship that is a relationship between the extended first type information, the extended second type information, and the extended third type information; deriving an extended second relationship that is a relationship between the extended first type information, the extended second type information, and the extended fourth type information; generating a model for estimating the fourth type information indicating the fourth type result of actual device machining by receiving the second type information measured during the actual device machining and the third type information measured during the actual device machining and using the extended first relationship and the extended second relationship; and outputting the model.

Furthermore, the program executes, on a computer, an estimation method including: inputting, to a model output by the generation method described above, the second type information measured during the actual device machining and the third type information measured during the actual device machining; and outputting, as estimation information obtained by estimating the fourth type result of the actual device machining, the fourth type information output from the model receiving the second type information and the third type information.

Items such as the estimation device according to one or more aspects have been described above based on the exemplary embodiment. However, the present disclosure is not limited to the exemplary embodiment. Configurations in which various variations conceived by those skilled in the art are applied to the present exemplary embodiment, and configurations constructed by combining the constituent elements in different exemplary embodiments may also fall within the scope of one or more aspects without departing from the spirit of the present disclosure.

A model generation method, a parameter estimation method, and a system according to the present disclosure enable parameter estimation of an objective variable with a small number of experiments even when explanatory variables include a parameter for which measurement data is not collected in-line, and are useful as a model generation method, a parameter estimation method, and a system.

What is claimed is:

1. A generation method executed by a processor using memory, the generation method comprising:
acquiring, by performing experimental device machining according to plan information including first type information indicating a first type condition of the experimental device machining and second type information indicating a second type condition of the experimental device machining, third type information indicating a third type result of the experimental device machining according to the plan information, and fourth type information indicating a fourth type result of the experimental device machining according to the plan information;
acquiring extended plan information including extended first type information including new first type information added to the first type information and extended second type information including new second type information added to the second type information, wherein a uniformity between the extended second type information and extended third type information obtained as the third type result of the experimental device machining performed according to the extended plan information is equal to or greater than a threshold value;
acquiring, by performing the experimental device machining according to the extended plan information, the extended third type information indicating the third type result of the experimental device machining according to the extended plan information and extended fourth type information indicating the fourth type result of the experimental device machining according to the extended plan information;
deriving an extended first relationship that is a relationship between the extended first type information, the extended second type information, and the extended third type information;
deriving an extended second relationship that is a relationship between the extended first type information, the extended second type information, and the extended fourth type information;
generating a model for estimating the fourth type information indicating the fourth type result of actual device machining by receiving the second type information measured during the actual device machining and the third type information measured during the actual device machining and using the extended first relationship and the extended second relationship; and
outputting the model.

2. The generation method according to claim 1, further comprising deriving a first relationship that is a relationship between the first type information, the second type information, and the third type information, wherein
the acquiring the extended plan information further includes:
acquiring the extended second type information by adding the new second type information to the second type information;
acquiring the extended third type information by adding new third type information to the third type information;
acquiring, by receiving the extended second type information and the extended third type information, the extended first type information using the first relationship; and
acquiring the extended plan information including the extended first type information and the extended second type information.

3. The generation method according to claim 1, wherein
the acquiring the extended plan information further includes:
determining whether or not the uniformity between the extended second type information and the extended third type information is equal to or greater than the threshold value; and
acquiring the extended plan information when determining that the uniformity between the extended second type information and the extended third type information is equal to or greater than the threshold value.

4. The generation method according to claim 1, wherein the acquiring the extended plan information further includes acquiring the extended plan information by adding new third type information to the third type information to add the new first type information belonging to a range from a minimum value to a maximum value in the first type information.

5. The generation method according to claim 1, wherein
the acquiring the extended plan information further includes:
calculating the uniformity between the extended second type information and the extended third type information using an average predicted variance of evaluation plan information including the second type information and the third type information as factors; and
acquiring the extended plan information using the uniformity calculated.

6. The generation method according to claim 2, wherein the acquiring the extended second type information and the acquiring the extended third type information further include acquiring the extended second type information and acquiring the extended third type information by D-optimal design for evaluation plan information including the second type information and the third type information as factors.

7. The generation method according to claim 1, wherein
the extended first relationship is expressed by an extended first expression that receives the extended first type information and the extended second type information and outputs the extended third type information, and
the model includes an extended third expression derived from the extended first expression, the extended third expression receiving the second type information measured during the actual device machining and the third type information measured during the actual device machining and outputting the first type information.

8. The generation method according to claim 7, wherein
the extended second relationship is expressed by an extended second expression that receives the extended first type information and the extended second type information and outputs the extended fourth type information, and
the model further includes a model including the extended second expression and acquiring the first type information output by the extended third expression and the fourth type information output by the extended second expression receiving the second type information measured during the actual device machining.

9. The generation method according to claim 1, wherein
each of the first type information and the fourth type information is information determined in advance as information that is not measured during the actual device machining, and
each of the second type information and the third type information is information determined in advance as information that is measured during the actual device machining.

10. The generation method according to claim 1, wherein
the machining is laser welding,
the first type information includes a gap width between plates to be welded in the laser welding,
the second type information includes a laser scanning speed in the laser welding,
the third type information includes a surface welding width of a laser welded portion in the laser welding, and
the fourth type information includes an interface welding width of the laser welded portion in the laser welding.

11. An estimation method comprising:
inputting, to a model output by the generation method according to claim 1, the second type information measured during the actual device machining and the third type information measured during the actual device machining; and
outputting, as estimation information obtained by estimating the fourth type result of the actual device machining, the fourth type information output from the model receiving the second type information and the third type information.

12. A generation device comprising:
a processor; and
memory connected to the processor; wherein using the memory, the processor:
acquires, by performing experimental device machining according to plan information including first type information indicating a first type condition of the experimental device machining and second type information indicating a second type condition of the experimental device machining, third type information indicating a third type result of the experimental device machining according to the plan information and fourth type information indicating a fourth type result of the experimental device machining according to the plan information;
acquires extended plan information including extended first type information including new first type information added to the first type information and extended second type information including new second type information added to the second type information, wherein a uniformity of the extended second type information and extended third type information obtained as the third type result of the experimental device machining performed according to the extended plan information is equal to or greater than a threshold value;
acquires, by performing the experimental device machining according to the extended plan information, the extended third type information indicating the third type result of the experimental device machining according to the extended plan information and extended fourth type information indicating the fourth type result of the experimental device machining according to the extended plan information;
derives an extended first relationship that is a relationship between the extended first type information, the extended second type information, and the extended third type information;
derives an extended second relationship that is a relationship between the extended first type information, the extended second type information, and the extended fourth type information;
generates a model for estimating the fourth type information indicating the fourth type result of actual device machining by receiving the second type information measured during the actual device machining and the third type information measured during the actual device machining and using the extended first relationship and the extended second relationship; and
outputs the model.

13. An estimation device comprising:
a processor; and
memory connected to the processor, wherein using the memory, the processor:
inputs, to a model output by the generation device according to claim 12, the second type information measured during the actual device machining and the third type information measured during the actual device machining; and
outputs, as estimation information obtained by estimating the fourth type result of the actual device machining, the fourth type information output from the model receiving the second type information and the third type information.
